(19) United States
(12) Patent Application Publication
(10) Pub. No.: US 2026/0346508 A1
(43) Pub. Date: Nov. 5, 2026

(54) METHOD TO AVOID CRACKS IN ENCAPSULATION OF SHARP-EDGED INSERTS

(71) Applicant: HUNTSMAN ADVANCED MATERIALS (SWITZERLAND) GMBH, Basel (CH)

(72) Inventors: Christian BEISELE, Basel (CH); Sophie COLLIARD, Basel (CH); Stephan COSTANTINO, Basel (CH); Zoubair CHERKAOUI, Basel (CH)

(21) Appl. No.: 19/119,890

(22) PCT Filed: Oct. 16, 2023
(86) PCT No.: PCT/EP2023/078675

§ 371 Date: Apr. 10, 2025

(30) Foreign Application Priority Data
Oct. 18, 2022 (EP) 22202250.1

(51) Int. Cl. B29C 39/10; B29K 63/00; B29K 75/00; B29K 105/00; B29L 31/34

(52) U.S. Cl. CPC B29C 39/10; B29K 2063/00; B29K 2075/00; B29K 2105/0094; B29K 2995/0013; B29K 2995/0077; B29K 2995/0097; B29L 2031/34

(57) ABSTRACT

A method to encapsulate inserts with an encapsulation resin, said method comprising:
a. Applying on part or all of the surface of the insert a coating layer of a thermosetting material,
b. Curing the coating layer resulting from step a.,
c. Encapsulating the coated insert resulting from step b. with an encapsulation resin.

The invention is directed to a method of avoiding cracks in encapsulation of sharp-edged inserts, for example inserts with lower coefficient of thermal expansion (CTE) than the encapsulation materials. It is also directed to kits of materials for encapsulating sharp-edged inserts and to articles resulting from the encapsulation. The method is based on application of a coating based on elastic material between the insert and the encapsulation material. Typical application is stator or rotor encapsulation for electrical engines or devices.

### STATE OF THE ART

It is known to encapsulate sharp edged inserts in electrical appliances such as stators or rotors, with a filled liquid resin system casted in the empty space remaining between the coil or inserts and the housing of the part. Encapsulation of stiff materials, for example materials with low CTE, and materials with potentially sharp edges, with a high glass transition temperature (Tg) material often leads to cracks during thermal cycles.

DE3702782 teaches a method for avoiding cracks by using flexible silicone rubber material for encapsulation of high voltage instrument transformers. The material disclosed in that document is too soft for the application targeted in the instant invention.

WO2010112272 discloses a curable composition comprising an epoxy resin and a specific filler mixture, for the direct overmolding of components or parts of electrical or electronic components, for example a switch gear. The curable composition is applied to the housing of electrical or electronic components, like a ceramic housing of a vacuum chamber of a switch gear. The special encapsulation composition disclosed in that document cannot be used for the targeted application because of its too low glass transition temperature (Tg).

WO2016202608 teaches curable compositions comprising a cationically polymerisable epoxy resin and a specific filler composition as insulating material for electric and electronic components, in particular as encapsulation system for printed circuit boards. The mixture of different fillers permits to adapt the CTE to reduce/avoid cracks, but the formulations disclosed are expensive with regards to the targeted application.

JP 2020 011457 A teaches applying two layers of different properties to provide for a laminate with excellent abrasion resistance and chemical resistance. The document is silent on providing the encapsulation of sharp-edged inserts with improved crack resistance.

US 2013/0294921 A1 teaches a two-component polyurethane composition with a long open time which can still be glued and cured to form a polymer having high mechanical strength.

It is known to the skilled professional that instrument transformers are produced using a cushioning/padding technique around the critical iron core to prevent cracking during thermal changes. This technique is implemented manually, it is labour intensive, thus costly, and cannot be applied to any shapes.

The technical problem, consisting of encapsulation of stiff materials with low CTE and potentially sharp edges with a high Tg material which should not lead to cracks during thermal cycles, is solved by WO2016202608. This document teaches an epoxy system containing a mixture of micro-meter and nano-meter scale SiO2 particles, allowing such high filler loads that lead to low CTE and hence low stress.

But the method is not applicable to encapsulation materials with a high Tg (for example Tg>160 °C) and has some disadvantages such as high cost and complex formulation.

The technical problem consisting of the formation of cracks in encapsulation materials is multifactorial. Among parameters which have an influence on its occurrence, one can mention: CTE, elongation at break, chemical shrinkage, toughness, thermal conductivity.

Thus, there remained the need for a method to encapsulate stiff materials, especially materials with sharp edges, with a high Tg material which should not lead to cracks during thermal cycles, said method being applicable on industrial scale at costs compatible with the targeted application.

### SUMMARY OF THE INVENTION

The invention is based on a method comprising the application and the cure of a thin layer of a specific resin system on the insert. Then, the standard process of encapsulating by casting the device, especially the electric or electronic device, can be implemented with an encapsulation resin, said encapsulation resin being already known from the prior art. Surprisingly, the presence of the coating layer leads to an improved crack resistance of this already known encapsulation resin.

A first object of the invention consists in a method for the encapsulation of an insert, said method comprising at least:
a. Applying on at least part of the surface of the insert a coating layer of a thermosetting material,
b. At least partly curing the coating layer resulting from step a.,
c. Encapsulating the coated insert resulting from step b. with an encapsulation resin,
wherein the thermosetting material of the coating layer is selected from those having a tensile modulus after curing in the range from 50 MPa to 1000 MPa, the tensile modulus being measured by the method ISO 527, and having an elongation at break after curing in the range from 20% to 500%, the elongation at break being measured by the method ISO 527.

A second object of the invention consists in a kit comprising a first resin system and a second resin system, that can be used in the method for the encapsulation of an insert, said kit comprising:
a thermosetting material selected from those having a tensile modulus after curing in the range from 50 MPa to 1000 MPa, the tensile modulus being measured by the method ISO 527, and having an elongation at break after curing in the range from 20% to 500%, the elongation at break being measured by the method ISO 527,
a resin system capable of encapsulating the insert.

A third object of the invention is a device consisting in an encapsulated insert, said device resulting from the implementation of the above defined method.

A fourth object of the invention consists in the use of a thermosetting material selected from those having a tensile modulus after curing in the range from 50 MPa to 1000 MPa, the tensile modulus being measured by the method ISO 527 and having an elongation at break after curing in the range from 20% to 500%, the elongation at break being measured by the method ISO 527, in a method as defined above, for avoiding cracks in the encapsulation of inserts.

Another object of the invention is a method for manufacturing electrical and electronic insulation equipment, wherein said method comprises at least one step consisting in implementing the method for the encapsulation of an insert as above disclosed and in detail here-under.

According to a favorite embodiment, the thermosetting material of the coating layer is selected from those having a viscosity in the range from 0.1 Pa·s to 10 Pa·s at 25 °C, viscosity being measured by the method ISO 3219.

According to a favorite embodiment, the thermosetting material of the coating layer is selected from polyurea, polyurethane and polyepoxy systems, preferably a polyurea system.

According to a favorite embodiment, the thermosetting material of the coating layer is a 2-component thermoset system comprising at least:
A component (A) selected from a di isocyanate or a polyisocyanate component, or mixtures thereof,
A component (B) selected from amines with at least 2 primary amine groups.

According to a favorite embodiment, component (A) is selected from: MDI, TDI, IPDI, HMDI or corresponding uretdions homopolymers, or prepolymers with polyols, or mixtures thereof.

According to a favorite embodiment, component (B) is selected from: jeffamines, polyamidoamines, aliphatic polyamines, cycloaliphatic polyamines or aromatic amines.

According to a favorite embodiment, the coating layer of thermosetting material is applied on the insert in a thickness ranging from 0.05 mm to 1 mm.

According to a favorite embodiment, in step b. of the method for the encapsulation of an insert, the coating layer is cured at a temperature ranging from 15 °C to 60 °C.

According to a favorite embodiment, the insert has a CTE in the range from 5 to 30 ppm/K, CTE being determined according to ISO 11359-2.

According to a favorite embodiment, the insert is selected from
an object with at least one geometrical angle between 1° and 120°, or
an object with at least one radius <3 mm.

According to a favorite embodiment, the insert is selected from rotors or stators of electrical machines such as motors or generators, (power)-electronic components, batteries, switchrings of e-motors, switchgears, printed circuit boards, bushings, transformers, dry-type transformers, instrument transformers, metallic inserts embedded in the structural material of insulators.

### DETAILED DESCRIPTION

Unless otherwise defined herein, technical terms used in connection with the present disclosure shall have the meanings that are commonly understood by those having ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the present disclosure pertains. All patents, published patent applications, and non-patent publications referenced in any portion of this application are herein expressly incorporated by reference in their entirety to the same extent as if each individual patent or publication was specifically and individually indicated to be incorporated by reference to the extent that they do not contradict the instant disclosure.

All of the compositions and/or methods disclosed herein can be made and executed without undue experimentation in light of the present disclosure. While the compositions and methods of the present disclosure have been described in terms of preferred embodiments, it will be apparent to those having ordinary skill in the art that variations may be applied to the compositions and/or methods and in the steps or sequences of steps of the methods described herein without departing from the concept, spirit, and scope of the present disclosure. All such similar substitutes and modifications apparent to those skilled in the art are deemed to be within the spirit, scope, and concept of the present disclosure.

As utilized in accordance with the present disclosure, the following terms, unless otherwise indicated, shall be understood to have the following meanings.

The use of the word “a” or “an”, when used in conjunction with the term “comprising”, “including”, “having”, or “containing” (or variations of such terms) May 25 mean “one”, but it is also consistent with the meaning of “one or more”, “at least one”, and “one or more than one”.

The use of the term “or” is used to mean “and/or” unless clearly indicated to refer solely to alternatives and only if the alternatives are mutually exclusive.

Throughout this disclosure, the term “about” is used to indicate that a value includes the inherent variation of error for the quantifying device, mechanism, or method, or the inherent variation that exists among the subject(s) to be measured. For example, but not by way of limitation, when the term “about” is used, the designated value to which it refers may vary by plus or minus ten percent, or nine percent, or eight percent, or seven percent, or six percent, or five percent, or four percent, or three percent, or two percent, or one percent, or one or more fractions therebetween.

The use of “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it refers. In addition, the quantities of 100/1000 are not to be considered as limiting since lower or higher limits may also produce satisfactory results.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The phrases “or combinations thereof” and “and combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more items or terms such as BB, AAA, CC, AABB, AACC, ABCCCC, CBBAAA, CABBB, and so forth. The skilled artisan will understand that typically there is no limit on the number of items or terms in any combination, unless otherwise apparent from the context. In the same light, the terms “or combinations thereof” and “and combinations thereof” when used with the phrases “selected from” or “selected from the group consisting of” refers to all permutations and combinations of the listed items preceding the phrase.

The phrases “in one embodiment”, “in an embodiment”, “according to one embodiment”, and the like generally mean the particular feature, structure, or characteristic following the phrase is included in at least one embodiment of the present disclosure, and may be included in more than one embodiment of the present disclosure. Importantly, such phrases are non-limiting and do not necessarily refer to the same embodiment but, of course, can refer to one or more preceding and/or succeeding embodiments. For example, in the appended claims, any of the claimed embodiments can be used in any combination.

As used herein, the term “ambient temperature” refers to the temperature of the surrounding work environment (e.g., the temperature of the area, building or room where the curable system is used or produced), exclusive of any temperature changes induced by a chemical reaction. The ambient temperature is typically between about 10 °C and about 30 °C, more specifically about 25 °C. The term “ambient temperature” is used interchangeably with “room temperature” herein.

The term “consists essentially of” followed by one or more characteristics, means that may be included in the process or the material of the invention, besides explicitly listed components or steps, components or steps that do not materially affect the properties and characteristics of the invention.

The expression “comprised between X and Y” includes boundaries, unless explicitly stated otherwise. This expression means that the target range includes the X and Y values, and all values from X to Y.

Throughout the description and claims of this specification, the words “comprise” and “contain” and variations of the words, for example “comprising” and “comprises”, mean “including but not limited to”, and do not exclude other moieties, additives, components, integers or steps. Moreover, the singular encompasses the plural unless the context otherwise requires: in particular, where the indefinite article is used, the specification is to be understood as contemplating plurality as well as singularity, unless the context requires otherwise.

Where upper and lower limits are quoted for a property, for example for the concentration of a component, then a range of values defined by a combination of any of the upper limits with any of the lower limits may also be implied.

### The Insert:

The method according to the invention applies to the encapsulation of inserts, for example inserts with lower CTE than the encapsulation materials.

The CTE of a material is measured according to ISO 11359-2.

For example, the inserts are characterized by a CTE in the range from 5 ppm/K to 30 ppm/K, preferably from 5 ppm/K to 25 ppm/K and more preferably from 10 ppm/K to 17 ppm/K

In the instant invention, inserts are objects made of a stiff material, like for example objects essentially made of metals (steel mainly and aluminum). Stiffness of a material is measured by its tensile modulus, which can be measured according to DIN EN ISO 6892-1

For example, the insert is made of a material chosen from those having a tensile modulus in the range from 70 to 250 GPa, preferably from 130 to 220 GPa.

The method according to the invention applies to inserts with all types of shapes, preferably, the method according to the invention applies to the encapsulation of sharp-edged inserts.

By “sharp-edged inserts” is meant, in the context of the invention:
an object with at least one geometrical angle between 1° and 120°, or
an object with at least one radius <3 mm.

FIG. 1a illustrates an object with a 2 mm radius (1) and a 90° angle (2).

FIG. 1b illustrates an object with a 1 mm radius (3) and a 100° angle (4).

The function of the insert can be of varied nature but is generally selected from electrical and electronic components. The invention applies notably to inserts which are parts of an equipment wherein the insert is submitted to thermal cycling during normal functioning.

Thermal cycling in the context of the invention means submitting the insert to a difference of temperature superior or equal to 50 °C, preferably superior or equal to 120 °C, better superior or equal to 190 °C. These temperature differences apply in a length of time between 5 minutes and 10 hours.

For example, the insert can be selected from rotors or stators of electrical machines such as motors or generators, (power)-electronic components, batteries, switchrings of e-motors, switchgears (gas-insulated-type and vacuum-type), printed circuit boards, bushings, transformers, dry-type transformers, instrument transformers, metallic inserts embedded in the structural material of insulators.

### The Coating Layer:

The invention relies on the application to the surface of the insert of a coating layer of a material, preferably as a liquid material, the coating material being at least partially cured after application in order to form a solid layer on the surface of the insert before the application of the encapsulation material.

The invention relies on the application to the surface of the insert of a coating layer based on an elastic material.

The cured coating layer should have a high flexibility and also should be compatible with the encapsulation system. Preferably, the material of the coating layer is selected so that the coating layer can chemically crosslink with the encapsulation system when the latter cures.

The coating material should have a satisfying viscosity to permit application of a homogeneous layer of sufficient thickness. For example, the coating material is chosen from those having a viscosity, before curing, in the range from 0.1 Pa·s to 10 Pa·s at ambient temperature, preferably from 0.2 Pa·s to 5 Pa·s. Viscosity is measured by the method ISO 3219.

The cured coating material should have sufficient elasticity to avoid the formation of cracks in the encapsulation material during and after thermal cycling.

For example, the cured coating material is chosen from those having a tensile modulus in the range from 50 MPa to 1000 MPa, preferably from 80 MPa to 400 MPa.

The tensile modulus is measured by the method ISO 527.

For example, the cured coating material is chosen from those having an elongation at break in the range from 20% to 500%, preferably from 40% to 250%, even more preferably from 50% to 200%.

The elongation at break is measured by the method ISO 527, on a sample of thickness 1 mm.

Advantageously, the coating is based on a material consisting of a 2-component thermoset system.

By “two-component thermoset system” is meant a composition comprising the two components as two pack systems (or kit) designed for extemporaneous mixing of the two components for formation of the coating shortly before curing.

When the two components are mixed/blended together and cured, they can form a cured solid coating by forming chemical bonds called crosslinks between the two components. Evaluation of the viscosity of the coating material is implemented after mixing the two components and before curing.

For example, the coating material can be selected from a polyurea system, a polyepoxy system, or a polyurethane system, provided that it has the appropriate physico-chemical properties, especially the viscosity, the tensile modulus and the elongation at break, in the above recited ranges.

Preferably, the coating material is based on a polyurea system, or preferably consists of a polyurea system.

Preferably, the coating material is based on a curable two-part resin system comprising a Component (A) and a Component (B), wherein:
Component (A) is an isocyanate component consisting of one or more di isocyanate or one or more polyisocyanate components, or mixtures thereof,
Component (B) is an amine component consisting of amines with at least 2 primary amine groups.

The polyisocyanate components (A) useful in producing a polyurea coating according to the present invention are well known in the art and are organic compounds that contain two, or greater than two, isocyanate groups per molecule. Isocyanate components (A) may be aromatic, cycloaliphatic or aliphatic and may be monomeric or oligomeric compounds.

Advantageously, the polyisocyanate component has an NCO functionality greater than or equal to 2, preferably ranging from 2 to 3.

The isocyanate “functionality” is the number of reactive NCO groups per molecule in an isocyanate molecule or in a polymeric isocyanate. For example, most polyisocyanates, in particular MDI-type polyisocyanate compounds, contain a blend of monomeric and polymeric MDI, and the isocyanate functionality is an average functionality across the different molecular and polymeric species.

As used herein, “MDI” refers to methylene diphenyl diisocyanate, also called diphenylmethane diisocyanate, and the isomers thereof. MDI exists as one of three isomers (4,4′ MDI, 2,4′ MDI, and 2,2′ MDI), or as a mixture of two or more of these isomers. Unless specifically stated otherwise, “MDI” may also refer to, and encompass, polymeric MDI. Polymeric MDI is a compound that has a chain of three or more benzene rings connected to each other by methylene bridges, with an isocyanate group attached to each benzene ring.

Suitable polyisocyanate component (A) that can be used in the coating according to the invention can for example be selected from dodecane-1,12-diisocyanate, 2-ethyltetramethylene-, 1,4-diisocyanate, 2-methylpentamethylene-1,5-diisocyanate, tetramethylene-1,4-diisocyanate, hexamethylene-1,6-diisocyanate (HMDI), cyclohexane-1,3-diisocyanate, cyclohexane-1,4-diisocyanate, isophorone diisocyanate (IPDI), hexahydrotoluene-2,4-diisocyanate, hexahydrotoluene-2,5-diisocyanate, dicyclohexylmethane-2,2′-diisocyanate, dicyclohexylmethane-4,4′-diisocyanate, dicyclohexylmethane-2,4′-diisocyanate, toluene-2,4-diisocyanate (2,4-TDI), toluene-2,6-diisocyanate (2,6-TDI), diphenylmethane-2,2′-diisocyanate (2,2′-MDI), diphenylmethane-4,4′-diisocyanate (4,4′-MDI), diphenylmethane-2,4′-diisocyanate (2,4′-MDI) polyphenylpolymethylene polyisocyanates (crude MDI), and mixtures thereof.

Commercially available diisocyanates often contain dimeric (uretdiones), trimeric (triazines) and oligomeric compounds, or prepolymers with polyols. In the coatings according to the invention these mixtures of monomers and oligomers can be employed without separation of byproducts or purification.

The amine components (B) useful in producing a polyurea coating according to the present invention are well known in the art and are organic compounds that contain two or greater than two primary amine groups per molecule. Amine components (B) may be aromatic, cycloaliphatic or aliphatic and may be monomeric or oligomeric compounds.

In principle any amine which is in the liquid state at ambient temperature can be used, such as for example jeffamines, polyamidoamines, aliphatic polyamines, cycloaliphatic polyamines such as isophorondiamine or aromatic amines for example dimethylthiotoluenediamine, diethyltoluenediamine.

A skilled professional knows how to select component (A), component (B) and their ratios to provide a polyurea system with the requested physico-chemical properties in the above recited ranges, especially the viscosity before curing, and the tensile modulus and the elongation at break after curing.

### The Encapsulation Resin:

The encapsulation resin is a curable material known from the prior art for the same or a similar use.

The invention finds application of particular interest when the cured encapsulation resin is a stiff material. For example, the resin system is chosen from those having a tensile modulus in the range from 5 GPa to 20 GPa, preferably from 10 GPa to 16 GPa after curing.

For example, the resin system is chosen from those having an elongation at break in the range from 0.1% to 5%, preferably from 0.4% to 2% after curing.

The invention finds application of particular interest when the cured encapsulation resin has a small coefficient of thermal expansion (CTE), i.e., a CTE less than or equal to 27 ppm/K more preferably less than 20 ppm/K at T<Tg.

The viscosity of the resin system is an important parameter for the processability of the resin system. Preferably, the resin system before curing has a viscosity in the range from 4 Pas to 30 Pas at 60 °C. Viscosity is measured by the method ISO 3219.

The invention finds application of particular interest when the cured encapsulation resin is a high glass transition temperature system, for example a system with a Tg>140 °C, preferably with a Tg>180 °C.

The Tg of the encapsulation resin can be evaluated by the method ISO 11359-2. Preferably, the resin system is selected from those having good long-term thermal aging stability (grade H according to IEC 60216).

Preferably, the resin system is selected from those having a very good thermal cycle crack resistance (SCT<−100 °C). The method to measure thermal cycle crack resistance is described in EP 1 165 688 B1 (page 9).

The encapsulation resin can be based on any material known for this use in the prior art, like for example two-component epoxy systems, polyurethanes, polyisocyanurates.

For the sake of illustration, some examples of resin systems that can be used in the invention as encapsulation systems are detailed below. However, this illustration should not be considered as limiting the scope of the invention.

According to a first embodiment, the encapsulation resin is a curable two-part resin system, comprising
(a) a resin part, comprising at least one epoxy resin, and
(b) a hardener part, comprising amine, or anhydride or isocyanate functionalities.

Alternately, the encapsulation resin may be a single component system, e.g. like described in WO2016/202608 A1.

According to the first embodiment, the curable two-part resin system can further comprise fillers, like inorganic fillers and/or metal powders. Said fillers are well known to the skilled professional.

According to a first example of this embodiment, the encapsulation resin can be based on the curable two-part resin system comprising epoxy resin and anhydride such as the Araldite® CW 30386/Aradur® HW 30387 system, which is commercially available from Huntsman.

According to a second example of this first embodiment, the encapsulation resin can be based on the curable two-part resin system comprising epoxy resin and isocyanate. Especially, the reaction-resin mixture can comprise:
a) A polyfunctional isocyanate,
b) An epoxy resin composition predominantly comprising a compound A′ based on glycidyl ether of aliphatic and/or cycloaliphatic alcohols having at least 2 alcohol functionalities, or a compound B′ based on glycidyl ester of aliphatic and/or cycloaliphatic carbonic acids having at least 2 carboxylic acid functionalities,
c) A cure accelerator.

According to a preferred embodiment of this example, said epoxy resin composition (predominantly) comprises butanediol diglycidyl ether, hexanediol diglycidyl ether, 1,4-cyclohexane dimethanol diglycidyl ether, hexahydrophthalic acid diglycidyl ester, trimethylolpropane triglycidyl ether, pentaerythritol polyglycidyl ether, neopentyl glycol diglycidyl ether, or mixtures thereof.

According to a preferred embodiment of this example, the equivalent ratio of isocyanate groups of component (a)—polyfunctional isocyanate—to epoxide groups of component (b)—epoxy resin—is from 10:1 to 1:1, preferably from 5:1 to 3:1.

Furthermore, the polyfunctional isocyanate is preferably selected from the group comprising alicyclic polyisocyanates, aromatic polyisocyanates and mixtures thereof.

In a particularly preferred embodiment of this example, the polyfunctional isocyanate is selected from the group comprising diphenylmethane-2,4- or -4,4′-diisocyanate; polyphenylene polymethylene polyisocyanate; diphenylmethane diisocyanates containing a carbodiimide group or uretonimide group; modified polyisocyanates containing an allophanate group, urethane group, biuret group and/or urethidione group; isocyanate based prepolymers obtained by reaction of an excess of the above mentioned polyisocyanates with polyols; and mixtures thereof.

In an advantageous embodiment of this example, the cure accelerator is based on boron trichloride-amine complex, being preferably selected from the group comprising boron trichloride-dimethyloctylamine complex, boron trichloride-trimethylamine complex, boron trichloride-benzyldimethylamine complex, boron trichloride-tributylamine complex, and mixtures thereof.

According to a preferred embodiment of this example, the cure accelerator is present in an amount between 0.01 and 5 wt %, preferably between 0.05 to 2.5 wt %, based on the total weight of said mixture.

According to a third example of this first embodiment, the curable two-part resin system can comprise:
(a) a resin part, comprising at least one cycloaliphatic epoxy resin and
(b) a hardener part, comprising (i) at least one alicyclic anhydride, and (ii) a block-copolymer comprising polysiloxane blocks and organic blocks, as disclosed in Application EP20216430.7

In one embodiment of this example, the organic blocks in the block-copolymer are polyester blocks, for example based on caprolactone or other lactones, or polycarbonate blocks. Non-limiting examples of suitable block-copolymers include polycaprolactone-polysiloxane block copolymer, polylactic acid-polysiloxane block copolymer and polypropylene carbonate-polysiloxane block copolymer. The polysiloxane blocks are for example polydimethylsiloxane blocks or polymethylethylsiloxane blocks. In one specific embodiment, the block-copolymer is a polycaprolactone-polysiloxane block copolymer such as Genioperl® W35 (Wacker Chemie AG, Munich, Germany).

In one embodiment of this example, the resin part (a) and hardener part (b) of the two-part resin system are present in a stoichiometric ratio±15 mol % of the resin part to the hardener part.

The cycloaliphatic epoxy resin may, for example, be selected from the group consisting of bis(epoxycyclohexyl)-methylcarboxylate, bis(2,3-epoxycyclopentyl) ether, 1,2-bis(2,3-epoxycyclopentyl) ethane, vinylcyclohexene dioxide, 3,4-epoxycyclohexylmethyl-3′,4′-epoxycyclohexane carboxylate, 3,4-epoxy-6-methylcyclohexylmethyl-3′,4′-epoxy-6′-ethylcyclohexane carboxylate, bis(3,4-epoxycyclohexylmethyl) adipate, bis(3,4-epoxy-6-methylcyclohexylmethyl) adipate, dicyclopentadiene dioxide, dipentene dioxide, 1,2,5,6-diepoxycyclooctane, 1,2,7,8-diepoxyoctane, 1,3-butadiene diepoxide, 3-ethyl-3-oxetanemethanol, and combinations thereof. In another embodiment, the cycloaliphatic epoxy resin is a non-glycidyl epoxy resin. In yet another embodiment, the cycloaliphatic epoxy resin is 3,4-epoxycyclohexylmethyl-3′,4′-epoxycyclohexancarboxylate.

In one embodiment, the alicyclic anhydride is an unsaturated compound. In a preferred embodiment, the alicyclic anhydride comprises 9 to 10 carbons. The alicyclic anhydride may, for example, be selected from the group consisting of methyltetrahydrophthalic anhydride (MTHPA), himic anhydride, methyl-5-norbornene-2,3-dicarboxylic anhydride (MNA), hexahydro-methylphthalic anhydride, tetrahydrophthalic anhydride, methylphthalic anhydride, naphthalic anhydride, dodecenylsuccinic anhydride and derivatives of succinic anhydride. In one particular embodiment, the alicyclic anhydride is methyltetrahydrophthalic anhydride (MTHPA), himic anhydride or methyl-5-norbornene-2,3-dicarboxylic anhydride (MNA).

According to another embodiment, the encapsulation resin is a single component system, like for example a cationically polymerisable epoxy resin in combination with a specific filler mixture such as disclosed in WO2016/202608.

Especially, according to this embodiment, the curable resin system comprises
(a) a cationically polymerisable epoxy resin,
(b) an initiator for the cationic polymerisation,
(c) a microparticle filler, and
(d) a nanoparticle filler.

### The Method Steps:

The invention is directed to a method to encapsulate inserts.

The invention is also directed to a method to manufacture encapsulated inserts.

The invention is further directed to a method for the manufacturing of electrical and electronic insulation equipment.

### The Method According to the Invention Comprises:

a. the application on the insert of a first layer of the coating material, then,
b. at least partly curing the coating layer resulting from step a., and
c. encapsulating the coated insert resulting from step b. with an encapsulation resin having a higher coefficient of thermal expansion than the insert material.

Advantageously, in step a. the coating is applied with a thickness between 0.05 mm and 1 mm on the surface of the insert, preferably between 0.1 mm and 0.5 mm. The coating is applied especially where the sharp edges are present. The application is not necessarily of equal thickness on all the surface of the insert, but preferably, the coating layer has regular thickness on all the surface of the insert where it is applied. Preferably, the coating layer is applied on the entire surface of the insert that will be encapsulated.

Application of the coating layer may be implemented by any method known to the skilled professional, like spraying, dipping, paint-brushing, spin coating. A method that can be mechanically implemented is preferred.

The coating layer is at least partly cured in step b., for example at a temperature between 15 °C and 60 °C.

Advantageously, in step b. the resin is cured at ambient temperature for 1 to 24 hours, preferably from 2 to 16 hours, more preferably from 4 to 12 hours.

In step c. the coated, partially cured, insert resulting from step b. is encapsulated in a known manner with the encapsulation resin. Briefly, the components of the encapsulation resin system are mixed, optionally with one or more mineral filler or metal powder, and applied to the insert. Application to the insert is for example by dipping, trickle impregnation, vacuum pressure impregnation and/or casting. Then the encapsulation resin system is cured according to the standard curing schedule, depending on the composition of this resin system.

### The Device:

The above disclosed method results in a device consisting of three parts: an insert, a coating layer covering part or all of the surface of the insert, and an encapsulation resin. Advantageously, there is no direct contact between the surface of the insert and the encapsulation resin, the coating layer intercalating between the insert and the encapsulation resin. Said devices can be used for electrical and electronic applications.

### The Use:

The invention results from the combination of a coating system with elastic properties intercalating between the insert and an encapsulation resin to obtain a combination effect which is the absence of cracks of the encapsulation resin after thermal cycling. The identification of cracks is by visual inspection.

When directly applied to the surface of the insert, the encapsulation system alone generally suffers from cracks during the thermal cycling tests. The coating alone is not usable as a casting system because it would not provide sufficiently high stiffness at high temperature.

The method according to the invention is useful not only for e-motor application, but also for example for crack-critical MV-Power applications, (e.g. certain bushings or switchgears or instrument transformers), which employ today costly toughened casting systems. By using the method according to the invention, the encapsulation of inserts for such applications can be done with cheaper untoughened casting systems.

### FIGURES

FIG. 1A is a drawing representing angles corresponding to sharp inserts

FIG. 1B is a drawing representing angles corresponding to sharp inserts

FIG. 2 is a drawing representing a cube insert in a cylindrical mould as used in example series 1

FIG. 3 is a picture representing a diamond insert in a cylindrical mould as used in example series 2

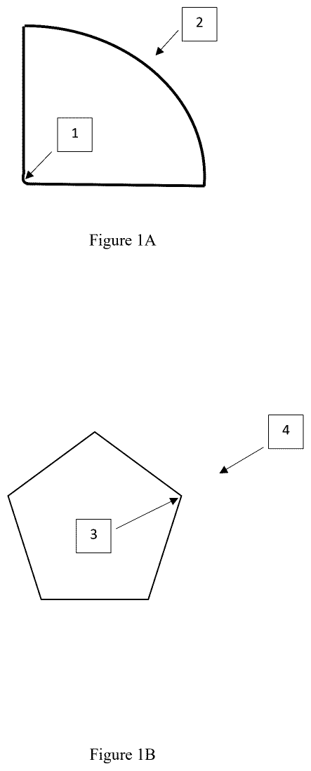

### EXPERIMENTAL PART

In the following examples, and unless otherwise indicated, the contents and percentages are given in mass.

### I—Raw Materials

### Polyisocyanate:

Rencast 6429A supplied by Huntsman, it is based on a blend of aliphatic and TDI based Isocyanate

### Polyamine:

Rencast 5425B supplied by Huntsman, it is a formulated hardener based on liquid aromatic amines
Rencast 5427B supplied by Huntsman, it is a formulated hardener based on liquid aromatic amines

### Encapsulation Resin:

Araldite® CW 30386 supplied by Huntsman, is a high Tg epoxy resin based on cycloaliphatic epoxy resin and inorganic fillers
Aradur® HW 30387 supplied by Huntsman, is a formulated hardener based on anhydride and fillers

### II—Methods

### Viscosity Measurement:

The compositions are subjected to Rheomat viscosimeter. The viscosity was measured according to ISO 3219.

### Tensile Modulus

Tensile modulus was determined at 23 °C according to ISO 527, with a sample of thickness 1 mm, cured 24 hours at 23 °C, then 4 hours at 80 °C.

### Elongation at Break

Elongation at break was determined at 23 °C according to ISO 527, with a sample of thickness 1 mm, cured 24 hours at 23 °C, then 4 hours at 80 °C.

### Glass Transition Temperature

The glass transition temperature Tg was determined according to ISO 6721/94.

### Coefficient of Linear Thermal Expansion

CTE is determined according to ISO 11359-2.

### Chemical Shrinkage

Chemical shrinkage is determined according to ISO 2579.

### Preparation of the Polyurea Coating System:

The polyurea system is prepared by mixing the polyisocyanate and the polyamine at room temperature in the prescribed ratios.

The compositions and their characteristics are reported in Table 1 below

TABLE 1
Example compositions

| | |
|---|---|
| Example 1 | Example 2 |

Polyisocyanate

| | | |
|---|---|---|
| Rencast 6429A | 100 | 100 |

Polyamine

| | | |
|---|---|---|
| Rencast 5425B | 24 | — |
| Rencast 5427B | — | 35 |

Characteristics

| | | |
|---|---|---|
| Viscosity at 25 °C (mPa · s) | 1900-2100 | 4400-4500 |
| Tg (°C) | Not measured | −30 |
| Tensile Modulus (MPa) | 370 | 100 |
| Elongation at break (%) | 150% | 80% |
| CTE (ppm/K) | 60-80 | 60-80 |
| T < Tg | | |
| CTE (ppm/K) | 140-280 | 140-280 |
| T > Tg | | |

### Preparation of the Encapsulation Resin

The encapsulation system consists of a mixture of CW 30386/HW 30387 with mix ratio of 100/130 by weight.

The mixture is introduced into the mould at 90 °C under vacuum and cured 20 min at 120 °C+3 hours at 190 °C in an oven. After this step all specimens were demoulded from the cylindrical aluminium housing.

### Properties of the Mixture are as Follows:

TABLE 1
Characteristics of the encapsulation resin system
Before curing

| | |
|---|---|
| Viscosity (Pa · s) | 6 |

After curing

| | |
|---|---|
| Tg (°C) | 200 |
| Elongation at break (%) | 0.7 |
| Tensile modulus (GPa) | 13 |
| CTE (ppm/K_{) T < Tg} | 19 |
| Chemical shrinkage (%) | <0.5 |

### Moulds and Inserts

### Mould and Insert Series 1:

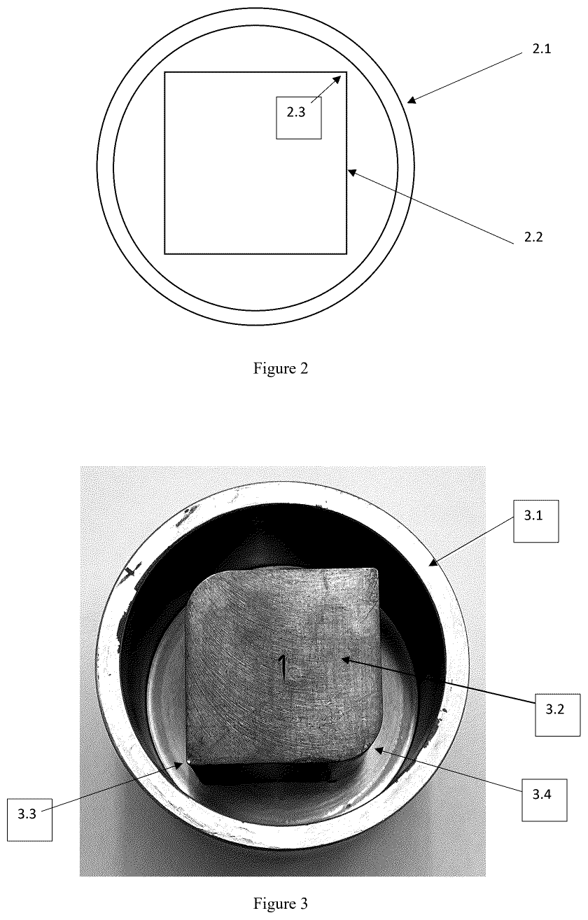

A representative aluminium mould and a first series of inserts have been used. They are illustrated on FIG. 2.

This mould is composed by a cylindrical housing (2.1) of 50 mm diameter made in aluminium. The insert is an aluminium cube (2.2) with a radius (2.3) of 0.2 mm.

### Mould and Insert Series 2:

The same aluminium mould and a second series of inserts have been used. They are illustrated on FIG. 3.

The mould is composed by a cylindrical housing (3.1) of 50 mm diameter made in aluminium. The insert (3.2) is in aluminium and diamond-shaped with rounded angles with radius (3.3) of 2 mm and (3.4) of 15 mm.

### Preparation of Encapsulated Inserts

For each of the mould and insert series 1 and 2, the following specimens were prepared:

6 Specimens were encapsulated without coating (control).

6 specimens were coated with a thin layer (0.2 mm) of the coating composition of example 1 and cured prior to the casting of the encapsulation resin system.

6 specimens were coated with a thin layer (0.2 mm) of the coating composition of example 2 and cured prior to the casting of the encapsulation system.

The coating was applied on the insert with a brush in a thickness of 0.2 mm and cured at 23 °C for 24 hours.

The encapsulation system consisting of a mixture of the above disclosed mixture is introduced into the mould at 90 °C under vacuum and cured in an oven in two steps: Step 1/during 20 min at 120 °C and Step 2/during 3 hours at 190 °C.

After this step all specimens were demoulded from the cylindrical aluminium housing.

The comparative example corresponds to the use of the same encapsulation system with the same casting and curing conditions as the examples, without the application of the coating prior to the casting. The comparative examples are reported as “control”.

### III—Tests and Results

### 1—Crack Resistance Test

### Test:

The samples are evaluated by visual inspection. The presence of cracks in the encapsulation system is visually detected and noted.

### Results

The test was implemented on the 3×6 specimens of the mould and insert series 1. The results are as follows: 5 samples according to the invention example 1 and 4 samples according to the invention example 2 show no signs of cracks.

The control (comparative) samples are all cracked after demoulding.

### 2—Thermal Shock Test

### Test:

To see the benefit of the new method, all the parts (coated and non-coated) were subjected to thermal shock starting from 20 °C and going down to −50 °C in 7 hours with steps of 1 hour at 20 °C, 10 °C, 0 °C, −10 °C, −20 °C, −30 °C, −40 °C, −50 °C.

The operator notes in each group the number of samples with cracks at each temperature.

### Results

The test was implemented on the 3×6 specimens of the mould and insert series 1. The results are as follows:

Results of the tests are reported in Table 3 below:

TABLE 3
thermal shock test

| | Control | Example 1 | Example 2 |
|---|---|---|---|
| Room Temperature | 6 | 1 | 2 |
| 0 °C | 6 | 1 | 2 |
| −10 °C | 6 | 1 | 2 |
| −20 °C | 6 | 1 | 2 |
| −30 °C | 6 | 1 | 2 |
| −40 °C | 6 | 1 | 2 |
| −50 °C | 6 | 1 | 3 |

All the control samples (not coated specimens) are cracked before the test.

5 specimens out of 6 from example 1 do not show any crack after the test.

4 specimens out of 6 from example 2 do not show any crack after the test. 1 specimen cracked at −50 °C. 5

### 3—Heat Resistance Test:

This test has been implemented on another set of specimens including different shape inserts corresponding to FIG. 3 (mould and insert series 2).

After casting and demoulding, the samples were exposed to 150 °C for 50 minutes and then directly moved to another chamber at −40 °C where they stay 50 minutes to 10 stabilise the temperature within the specimen.

### Results

The test was implemented on the 3×6 specimens of the mould and insert series 2. The results are gathered in the Table 4 below. In table 4 are reported the number of samples (out of 6) which show cracks after a certain number of thermal cycles. After 300 cycles none of the coated specimen is cracked, whereas all specimens which did not receive the coating prior to the casting (control) cracked after 10 cycles max.

TABLE 4
thermal cycling test

| Number of cycles | Control | Example 1 | Example 2 |
|---|---|---|---|
| 0 | 5 | 0 | 0 |
| 1 | 5 | 0 | 0 |
| 10 | 6 | 0 | 0 |
| 25 | 6 | 0 | 0 |
| 50 | 6 | 0 | 0 |
| 100 | 6 | 0 | 0 |
| 200 | 6 | 0 | 0 |
| 300 | 6 | 0 | 0 |

1. A method to encapsulate inserts, said method comprising at least:
a. Applying on at least part of the surface of the insert a coating layer of a thermosetting material,
b. At least partly curing the coating layer resulting from step a.,
c. Encapsulating the coated insert resulting from step b. with an encapsulation resin, wherein the thermosetting material of the coating layer is selected from those having a tensile modulus after curing in the range from 50 MPa to 1000 MPa, the tensile modulus being measured by the method ISO 527, and having an elongation at break after curing in the range from 20% to 500%, the elongation at break being measured by the method ISO 527.

2. The method as claimed in claim 1, wherein the thermosetting material of the coating layer is selected from those having a viscosity in the range from 0.1 Pa·s to 10 Pa·s at 25 °C, viscosity being measured by the method ISO 3219.

3. The method as claimed in claim 1, wherein the thermosetting material of the coating layer is selected from polyurea, polyurethane and polyepoxy systems, preferably a polyurea system.

4. The method as claimed in claim 1, wherein the thermosetting material of the coating layer is a 2-component thermoset system comprising at least:
A component (A) selected from a di isocyanate or a polyisocyanate component, or mixtures thereof,
A component (B) selected from amines with at least 2 primary amine groups.

5. The method as claimed in claim 4, wherein component (A) is selected from: MDI, TDI, IPDI, HMDI or corresponding uretdions homopolymers, or prepolymers with polyols, or mixtures thereof.

6. The method as claimed in claim 4, wherein component (B) is selected from: jeffamines, polyamidoamines, aliphatic polyamines, cycloaliphatic polyamines or aromatic amines.

7. The method as claimed in claim 1, wherein the coating layer of thermosetting material is applied on the insert in a thickness ranging from 0.05 mm to 1 mm.

8. The method as claimed in claim 1, wherein in step b., the coating layer is cured at a temperature ranging from 15 °C to 60 °C.

9. A kit for encapsulating inserts for use in a method as claimed in any one of claim 1, said kit comprising:
a thermosetting material selected from those having a tensile modulus after curing in the range from 50 MPa to 1000 MPa, the tensile modulus being measured by the method ISO 527 and having an elongation at break after curing in the range from 20% to 500%, the elongation at break being measured by the method ISO 527,
a resin system capable of encapsulating the insert.

10. A device consisting in an encapsulated insert, said device resulting from the implementation of the method according to any one of claim 1.

11. A device as claimed in claim 10, wherein the insert has a CTE in the range from 5 ppm/K to 30 ppm/K, CTE being determined according to ISO 11359-2.

12. A device as claimed in claim 10, wherein the insert is selected from
an object with at least one geometrical angle (2; 4) between 1° and 120°, or
an object with at least one radius (1; 3)<3 mm.

13. The device as claimed in any one of claim 10, wherein the insert is selected from rotors or stators of electrical machines such as motors or generators, (power)-electronic components, batteries, switchrings of e-motors, switchgears, printed circuit boards, bushings, transformers, dry-type transformers, instrument transformers, metallic inserts embedded in the structural material of insulators.

14. The use of a thermosetting material selected from those having a tensile modulus after curing in the range from 50 MPa to 1000 MPa, the tensile modulus being measured by the method ISO 527 and having an elongation at break after curing in the range from 20% to 500%, the elongation at break being measured by the method ISO 527, in a method as defined in any one of claim 1, for avoiding cracks in the encapsulation of inserts.

15. A method for manufacturing electrical and electronic insulation equipment, wherein said method comprises at least one step consisting in implementing the method for the encapsulation of an insert as claimed in any one of claim 1.
